(19) United States
(12) Patent Application Publication
(10) Pub. No.: US 2021/0406437 A1
(43) Pub. Date: Dec. 30, 2021

(54) PROGRAMMABLE CHIP, DESIGN METHOD AND DEVICE

(71) Applicants: Guosheng WU, Qingdao, Shandong (CN); QINGDAO ROBEI ELECTRONICS CO., LTD, Qingdao, Shandong (CN)

(72) Inventor: Guosheng WU, (US)

(21) Appl. No.: 17/289,003

(22) PCT Filed: Nov. 21, 2018
(86) PCT No.: PCT/CN2018/116804

§ 371 Date: Apr. 27, 2021

(51) Int. Cl. G06F 30/3308; G06F 30/12

(52) U.S. Cl. CPC G06F 30/3308; G06F 2119/22; G06F 30/12

(57) ABSTRACT

A programmable operation and control chip, comprising: at least one controller with a control flow operation mode; at least one bus; at least one programmable operation structure with data stream flow operation mode which communicates with the controller via the bus and the data buffering structure to control and schedule the programmable operation structure and/or the data buffering structure, and allocate and process serial and parallel operation of data and/or dynamically reconfigure internal structure of the chip.

### CROSS REFERENCE

This application claims the priority of PCT/CN2018/116804 filed on Nov. 21, 2018.

### FIELD OF THE INVENTION

The present disclosure relates to an electronic device, in particular to a programmable chip, an application method of the chip and device with the chip.

### BACKGROUND

Developments of science and technology have raised higher and higher requirements on chip design and manufacturing. Adopting System on Chip (SoC), which utilizing IP core reuse and hardware/software co-verification become the mainstream method for high performance integrated circuit design. It has also become a huge systematic engineering from chip system definition through front end circuit design, back end physical implementation, chip manufacturing, encapsulation and testing, software development, to the final massive production. High performance and low power consumption are two opposite directions for chip design, and computing chip companies are all seeking to find a solution for both high performance and low power consumption.

### SUMMARY OF THE INVENTION

The present application discloses a programmable chip, a method and a device that can realize operation processing with high efficiency and low power consumption.

Other features and advantages of the present disclosure will become apparent through the following detail description or be learned partially by practicing the present disclosure.

In accordance with an aspect of the disclosure, it provides a programmable chip including: at least one controller with control flow operation mode; at least one bus; at least one programmable operation structure with data flow operation mode which communicates with the at least one controller via the at least one bus; and at least one data buffering structure exchanging data with the at least one programmable operation structure, the at least one data buffering structure including a buffer and/or a buffer array, wherein the at least one controller is configured to control and schedule the at least one programmable operation structure and/or the at least one data buffering structure, allocate and process serial and parallel operation of data and/or dynamically reconfigure the at least one programmable operation structure.

In accordance with some embodiments, the at least one controller includes at least one of CPU, DSP, MCU, GPU and DMA controllers.

In accordance with some embodiments, the at least one controller further may be configured to control the execution flow of the data flow operation, which includes controlling and scheduling the programmable operation structure executing data flow operations.

In accordance with some embodiments, the at least one controller is further configured to control the execution flow of control flow operations, which includes implementing at least one of serial operation, reading data, writing data, hopping, interruption and small amount data operation.

In accordance with some embodiments, the at least one data buffering structure includes a parallel or high speed serial high bandwidth memory/memory array.

In accordance with some embodiments, the at least one data buffering structure exchanges data with the at least one controller for control flow operations and periphery devices via at least one bus or a highly parallel DMA.

In accordance with some embodiments, the at least one data buffering structure includes a plurality of data buffering structures distributed around the at least one programmable operation structure and including the first data buffering structure and the second data buffering structure; the chip is configured to cause a first data to be output to the at least one programmable operation structure from the first data buffering structure and output a second data after operation by the at least one programmable operation structure to the second data buffering structure or the first data buffering structure.

In accordance with some embodiments, the plurality of data buffering structures and the at least one programmable operation structure are configured to implement ping-pong operations of data: outputting a first data from the first data buffering structure, outputting a second data via the at least one programmable operation structure to the second data buffering structure, and then outputting results from operations by the reconfigured at least one programmable operation structure to the first data buffering structure.

In accordance with some embodiments, the at least one data buffering structure is implemented with a plurality of dual port RAMs or one or more high bandwidth RAMs, and the RAMs are implemented in forms of registers, SRAMs, MRAMs, RRAMs, RERAMs or eFlashes.

In accordance with some embodiments, the chip further includes: at least one bus switch disposed between the at least one programmable operation structure and the at least one data buffering structure, the at least one bus switch bing a programmable or dynamically reconfigurable cross connection structure for connecting the at least one data buffering structure and the at least one programmable operation structure.

In accordance with some embodiments, the at least one controller controls the at least one programmable operation structure to execute data flow operations and determines whether to execute data flow operations by the at least one programmable operation structure according to an equation:

T_conf+T_delay*N/Path«N*T_n (1)

wherein, T_conf is a time at which the at least one programmable operation structure is configured; T_delay is a maximum delay of the data path; N is a number of data to be computed; Path is a number of parallel operations; and T_n is a time required to complete operation for each data in common serial control flow operation mode.

In accordance with some embodiments, the at least one programmable operation structure comprises at least one of FPGA, DSP, adaptive chip, artificial intelligent operation structure and network on chip.

In accordance with some embodiments, the adaptive chip comprises a plurality of dynamically reconfigurable units arranged in array, each dynamically reconfigurable unit is connected with surrounding 4˜8 adjacent dynamically reconfigurable units and connected with non-adjacent dynamically reconfigurable units via a plurality of data transfer lines above and below it, the each dynamically reconfigurable unit obtains data from one or more of connected input ends and outputs operation results based on the data to at least one connected dynamically reconfigurable units or data transfer lines.

In accordance with some embodiments, each dynamically reconfigurable unit may be dynamically reconfigured as desired, and operation instructions executed by each dynamically reconfigurable unit may be different. Instructions executed by the dynamically reconfigurable units depend on the following equation:

$$\{ cout , Result \} = f ( {\sum }_{n = 0}^{N} {a}_{n} δ ( {x}_{a} - Sela ) , {\sum }_{n = 0}^{N} {b}_{n} δ ( {x}_{b} - Selb ) , {\sum }_{n = 0}^{N} {cin}_{n} δ ( {x}_{c} - Selc ) ) \qquad ( 2 )$$

wherein Sela is a data source specified by configuration of data A, Selb is a data source specified by configuration of data B, Selc is a data source specified by configuration of data Cin, Xₐ are all possible sources of data A, X_{b} are all possible sources of data B, X_{c} are all possible sources of data Cin, N is a path of source through which each data signal may be obtained, f is an operation function; aₙ, bₙ, cinₙ are data on a nth way of A, B, Cin respectively, Result is a function result output, cout is a carry bit or flag bit output, δ(xₐ−Sela), δ(x_{b}−Selb) and δ(x_{c}−Selc) are unit pulse response functions, and if and only if Xₐ=Sela, X_{b}=Selb, and X_{c}=Selc the above three functions are 1s, otherwise 0s.

In accordance with some embodiments, each dynamically reconfigurable unit includes an arithmetic logic timing unit configured to implement at least one of arithmetic operation, logic operation, lookup operation, path selection operation, floating-point operation, null operation, timing delaying and counting.

In accordance with some embodiments, the plurality of dynamically reconfigurable units may be configured to implement complex instructions by combining at least two of them, and the complex instruction is implemented by combining a plurality of basic operation instructions.

In accordance with some embodiments, the at least one programmable operation structure implements algorithm of serial operations in a pipeline or parallel mode.

In accordance with some embodiments, the at least one programmable operation structure is partitioned into at least two operation areas that may implement configuration and operation in an overlapping and parallel manner, thereby realizing parallelized processing and data overlapping and reuse in data processing.

In accordance with some embodiments, the at least one programmable operation structure adopts a configuration buffer mode.

In accordance with some embodiments, the at least one programmable operation structure comprises a first programmable operation structure and a second programmable operation structure, while the first programmable operation structure is being configured, the second programmable operation structure implements operations, and after the configuration and operations are completed, the second programmable operation structure switches to configuration and the first programmable operation structure switches to operation.

In accordance with some embodiments, the chip further includes a plurality of storage interfaces, the plurality of storage interfaces being configured to attach one or more DDR memories, one or more HBM highly parallel memories, one or more HMC memories, one or more SSD/SATA memories with PCIE/USB interfaces, one or more memories with optical communication interfaces and one or more network memories with high speed Ethernet interfaces, one or more built-in MRAM/RRAM/eFlash/SRAM/DRAM memories and other high speed interfaces for high speed storage.

In accordance with some embodiments, the chip further includes a plurality of programmable interfaces each of which re-defines internal connections by program settings to enable a plurality of structures inside the chip to communicate with outside.

In accordance with some embodiments, the chip further includes one or more of MIPI/USB/HDMI/VGA display interfaces, image sensor interfaces, laser radar sensor interfaces, voice interfaces, AD/DA converting interfaces and Serdes interfaces.

In accordance with some embodiments, the at least one programmable operation structure comprises at least one programmable operation array.

In accordance with some embodiments, the chip further includes high speed communication interfaces for communications between the chips such that a plurality of chips are connected and processing in array.

In accordance with some embodiments, the plurality of chips and/or the plurality of chips and memories may adopt an encapsulation technology that encapsulates multiple modules together such as SIP.

In accordance with some embodiments, stacked encapsulation is used for the plurality of chips, and master and slave chips are set among the plurality of chips, thereby implementing dynamic scheduling.

In accordance with another aspect of the present invention, there is provided a simulation method for the chip as described in any of the previous items, including: constructing a plurality of simulation modules each corresponding to a hardware operation unit of the chip; simulating clock pulses with a register status update function in each simulation module; calling the register status update function to update clock status; and simulating operations by respective hardware unit of the chip in each clock cycle with each simulation module.

In accordance with some embodiments, the simulation method further includes: subjecting simulation modules that need clock status updating to data updating in a specific order.

In accordance with some embodiments, the simulation method further includes: detecting respective register status of each clock in the hardware operation unit in real time by setting step by step execution.

In accordance with some embodiments, the simulation method further includes: subjecting the at least one programmable operation structure to attribute editing in form of Model-View.

In accordance with another aspect of the present invention, there is provided a method for the chip as described in any of the previous items, including: classifying operations into control flow operations and data flow operations; writing configurations corresponding to data flow operations into the at least one programmable operation structures and filling data into the at least one programmable operation structures such that the at least one programmable operation structures implement data flow operations with the filled data.

In accordance with another aspect of the present invention, there is provided a method for the chip as described in any one of the previous items, including: compiling the data flow operations from a programming language to a data flow graph (DFG) file; transforming the data flow graph (DFG) file into a configuration file; and sending the configuration file to a simulation tool for simulation or writing the configuration file into the at least one programmable operation structure.

It will be understood that the above general description and the following detail description are only illustrative rather than limiting the present disclosure.

### BRIEF DESCRIPTION OF DRAWINGS

The above-described and other features and advantages of the present disclosure will become more apparent by describing example embodiments thereof in detail with reference to the accompanying drawings.

FIG. 1 shows a diagram of an programmable chip according to an example embodiment of the present disclosure;

FIG. 2 shows structure and timing for the data buffering structure and the programmable operation structure configured for ping-pong operation of data according to another embodiment of the present disclosure;

FIG. 3 shows an adaptive chip that may function as the programmable operation structure according to an embodiment of the present disclosure;

FIG. 4 shows the programmable operation structure with configuration buffer mode according to an example embodiment of the present disclosure;

FIG. 5 shows a diagram of a bus switch adjusting each line of data in the data buffering structure and the connection mode of the programmable operation structure according to an example embodiment of the present disclosure;

FIG. 6 shows a diagram of configuring a plurality of programmable operation structures according to an example embodiment of the present disclosure;

FIG. 7 shows a simulation method for the chip according to an example embodiment of the present disclosure;

FIG. 8 shows an interface diagram illustrating editing attributes of the programmable operation structure in form of Model-View according to an example embodiment of the present disclosure;

FIG. 9 shows a flow chart of a method for the chip according to an example embodiment of the present disclosure;

FIG. 10 shows a flow chart of a method for the chip according to an example embodiment of the present disclosure.

### DETAILED DESCRIPTION

Example embodiments will be described more extensively with reference to accompany drawings now. However, example embodiments may be implemented in various forms and should not be interpreted as being limited to embodiments set forth herein. On the contrary, these embodiments are provided to make the present disclosure more extensive and complete and convey the concepts of example embodiments to those skilled in the art fully. In the drawings, the same reference numerals represent the same or similar parts and redundant descriptions of them will therefore be omitted.

In addition, the described features, structures, or characteristics may be incorporated in one or more embodiments in any suitable manners. In the following descriptions, many specific details are provided to present a thorough understanding of embodiments of the present disclosure. However, one skilled in the art will understand that the technical solution of the present disclosure may be practiced without one or more of the described details or with other methods, elements, modules or steps. In other cases, well known structures, methods, devices, implementations, modules or operations will not be shown or described in detail for concision of the description.

Block diagrams shown in the drawings are only functional entities which do not necessarily correspond to physically separate entities. That is, it is possible to implement these functional entities in various forms or in one or more hardware modules or circuit units.

If a core of CPU or DSP is regarded as a robot in a pipeline, the present architecture design for CPU always focuses on how to improve the efficiency of instruction execution. Measures for this are continuously increasing basic frequency and add more pipelines (typically more than 20 pipelines for a present CPU). Although this robot in pipeline has different lengths, there is only one computing unit. Each computation needs an instruction and each instruction basically needs to go through several steps such as fetching instruction, decoding, fetching data, computing and storing back. Among them, fetching instruction, fetching data and storing back need to operate the buffer and even storage, which consumes large amount of power. Decoding and computing consume much less power. Computing consumes less than ⅛ of the power consumption of the entire pipeline. However, data computation is the core for a computer. That is, if instruction parsing (CPU, GPU and DSP) architectures are adopted, the effective power utilization is less than 12.5%. The more stages, the fewer operations of each instruction related to computing, and the lower effective power consumption.

High performance and low power consumption are two opposite directions for chip design, and chip companies are all seeking to find a solution for both high performance and low power consumption. One approach is FPGA embedded with ARM cores for low power consumption and high performance. But this solution will definitely increase the project design difficulty as FPGA and CPU are different in terms of programming and principles. Even if it is possible to convert C/C++/SystemC into RTL by high-level language synthesis, it is difficult to control their timings in an environment with combination of hardware and software. This solution requires that designers should have good command of design modes for totally different software and hardware. But these two design modes are conflicted, it is very difficult for a common person to switch and master them.

Another way is to develop a multi-core network on chip. Hundreds and thousands of simplified RISC processor cores are integrated in a chip and communications occur among cores via ad-hoc network protocols. When large amount of data enters, each core needs to identify packages transmitted to its location, execute data if confirming the packages belong to itself, and otherwise forward them to the next core. Transmission of mass data over multi-core network on chip would drastically reduce data arrival time, and increase latency and power consumption. Waiting at each core, instruction parsing and package identification are all key factors for increase of power consumption. Therefore, the biggest problem with a multi-core system is multi-core cooperation and scheduling, and a multi-core system cannot play a powerful role equivalent to the summation of every cores. Improvements in multi-core computing performance cannot exploit power of every core. In contrast, the multi-core system increases power consumption instead, which leads to a reduced computing energy efficiency.

According to a technical concept of an aspect of the present disclosure, a SOC architecture is proposed that may have a plurality of CPUs, a plurality of memory controllers and a plurality of interfaces. In order to realize high performance parallel processing, these unit modules are effectively integrated for efficient processing and low power consumption.

According to a technical concept of another aspect of the present disclosure, there is proposed a hardware/software implementation for a high speed dynamically reconfigurable hardware/software structure. Hardware includes one or more controllers (which may be CPU/DSP/MCU/GPU/other processors), one or more dynamically reconfigurable programmable operation structure, one or more data scheduling controllers (DMA), one or more storage controllers (DDR/HBM/HMC/SSD etc.), one or more external high speed interfaces (optical communication/PCIE/USB/Ethernet/MIPI) and a bus.

According to a technical concept of another aspect of the present disclosure, those suitable for control flow computation may be run on CPU, and for those suitable for data flow operations, configurations are first placed into the programmable operation structure and data is filled in batch for parallel operation. For example, for data flow computation, large amount of data is implemented by the same operation algorithm, and the rest is control flow computation.

According to a technical concept of another aspect of the present disclosure, the programmable chip architecture consists of traditional structure plus parallel structure. In traditional structure, data is forwarded with internal buffer, periphery interfaces of different bandwidths and different speeds are connected via bus, and at the same time the controller (e.g., CPU) may implement cooperation of multiple chips via high speed bus. The parallel structure may use the programmable operation structure as main part, and parallel buffers and high bandwidth high speed access interfaces are distributed around the programmable operation structure to directly interface with a plurality of DDR memories, a plurality of SSD memory devices, HBM or 3D memory grains. Cooperative parallel storage of parallel processor and cache of CPU may be exchanged by high speed data, and may also function as buffer for high bandwidth high speed access interfaces. The bus traverses every row and every column of the programmable operation structure to implement internal data hops and save transfer delay. The CPU section is responsible for running operating system, executing conventional software and read/write interfaces, so as to be compatible with traditional CPU operation software. The programmable operation structure section is responsible for novel operation modes, parallelizing data processing and reducing power consumption, thereby implementing novel modes of software-defined chips. The programmable operation structures may be classified into levels such as heterogeneous 256-core, 1024-core, 4096-core and 16384-core according to different application levels. It is also possible to implement a combination of a plurality of programmable operation arrays in a single chip and implement seamless switch between dual configurations or multiple configurations, thereby further improving parallel combining capability.

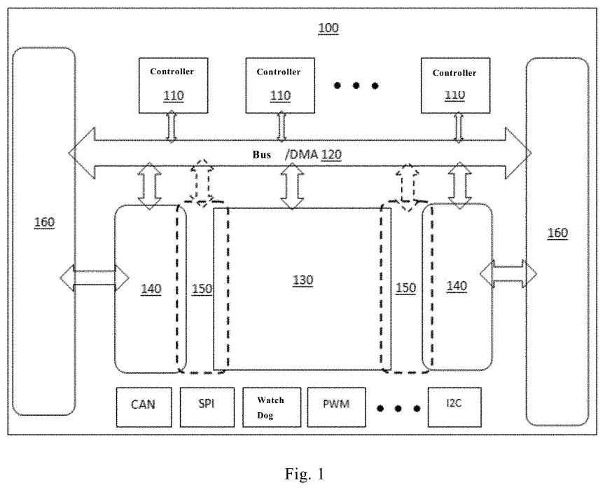

FIG. 1 shows a diagram of a programmable chip according to an example embodiment of the present disclosure.

Referring to FIG. 1, the programmable chip 100 according to an example embodiment of the present disclosure includes: at least one controller 110 with control flow operation mode; at least one bus 120; at least one programmable operation structure 130 with data flow operation mode which communicates with the at least one controller via the at least one bus; and at least one data buffering structure 140 exchanging data with at least one programmable operation structure 130 and including a buffer and/or a buffer array.

In the structure shown in FIG. 1, the at least one controller 110 is configured to control and schedule the at least one programmable operation structure 130 and/or the at least one data buffering structure 140, allocate and process serial and parallel data operations and/or dynamically reconfigure the at least one programmable operation structure 130.

In accordance with some embodiments, the programmable operation structure 130 includes a programmable operation array. In accordance with some embodiments, the programmable operation structure 130 may include at least one of FPGA, DSP, adaptive chip, artificial intelligent operation structure and network on chip.

In accordance with some embodiments of the present disclosure, the programmable operation structure 130 implements algorithm of serial operations in a pipeline or parallel mode.

In accordance with some embodiments of the present disclosure, the programmable operation structure 130 may be partitioned into at least two operation areas that may implement configuration and operation in an overlapping and parallel manner, thereby realizing parallelized processing and data overlapping and reuse in data processing.

In accordance with some embodiments, the controller 110 includes at least one of CPU, DSP, MCU, GPU, DMA, etc. controllers.

In accordance with some embodiments, the controller 110 is further configured to control the execution flow of the data flow operation, which includes controlling and scheduling the programmable operation array executing data flow operations.

In accordance with some embodiments, the controller 110 is further configured to control the execution flow of control flow operations, which includes implementing at least one of serial operation, reading data, writing data, hopping, interruption and small amount data operation. For example, the controller 110 executes control flow operations to implement sequence control of accurate timings for execution flow.

In accordance with some embodiments, the data buffering structure 140 includes a parallel or high speed serial multi-port high bandwidth memory/memory array. In accordance with some embodiments, the data buffering structure 140 may be implemented with a plurality of dual-port RAM or one or more high bandwidth RAMs. For example, implementation forms of RAM include register, SRAM, MRAM, RRAM, RERAM or eFlash, etc. For example, each dual-port RAM may have both input and output ports that may be operated at the same time. When the data buffering structure 140 is configured in Memin mode, it is possible to write data via bus, wherein the bit width for one time writing is the bus width and data may be written by addresses; and it is also possible to input data in parallel via external high speed interface or external storage controller, wherein the bit width for parallel data input is adjustable. When the data buffering structure 140 is full or has data therein, after triggering the data transfer instruction, every row of RAMs, as output ports, write data into the high speed dynamically reconfigurable logic array in parallel. A dual port RAM will record significant bits for each piece of data in which the significant bit is 0 if the data is invalid, and otherwise 1.

In accordance with some embodiments, the data buffering structure 140 exchanges data with the controller 110 for control flow operations and periphery devices via at least one bus 120 or a highly parallel DMA.

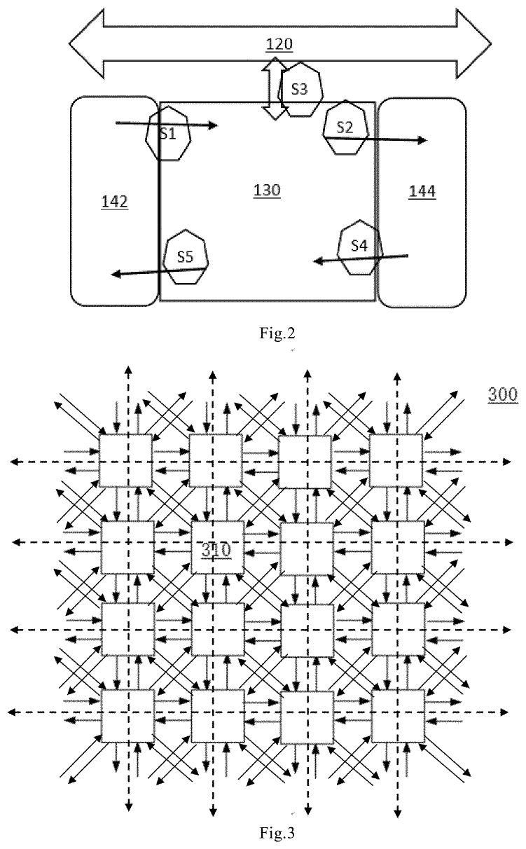

In accordance with some embodiments, the data buffering structure 140 includes a plurality of data buffering structures distributed around the programmable operation structure 130. In accordance with some embodiments, referring to FIG. 2 for example, the plurality of data buffering structures 140 include the first data buffering structure 142 and the second data buffering structure 144. The chip 110 is configured to cause the first data to be output to the programmable operation structure 130 from the first data buffering structure 142 and output the second data after operation by the programmable operation structure 130 to the second data buffering structure 144 or the original first data buffering structure 142.

In accordance with some embodiments, the chip 100 further includes a bus switch 150. The bus switch 150 is disposed between the programmable operation structure 130 and the data buffering structure 140. The bus switch 150 may be a programmable or dynamically reconfigurable cross connection structure for connecting the data buffering structure 140 and the programmable operation structure 130, as shown in FIG. 5. It is also possible to interpose the bus switch among a plurality of programmable operation structures 130 in dynamically reconfigurable manner. The bus switch 150 is configured with bus or DMA. The bus switch 150 may implement direct transfer switching of data among different rows or columns.

In accordance with some embodiments, the chip 100 further includes a plurality of storage interfaces 160. The storage interfaces 160 are configured to attach one or more DDR memories, one or more HBM highly parallel memories, one or more HMC memories, one or more SSD/SATA memories with PCIE/USB interfaces, one or more memories with optical communication interfaces and one or more network memories with high speed Ethernet interfaces. The chip 100 may further include one or more built-in MRAM/RRAM/eFlash/SRAM/DRAM memories for high speed storage.

In accordance with some embodiments, the chip 100 further includes a plurality of programmable interfaces each of which re-defines internal connections by program settings to enable a plurality of structures inside the chip to communicate with outside.

In accordance with some embodiments, the chip 100 further includes one or more of MIPI/USB/HDMI/VGA display interfaces, image sensor interfaces, laser radar sensor interfaces, voice interfaces, AD/DA converting interfaces and serdes interfaces.

In accordance with some embodiments, the chip 100 further includes high speed communication interfaces for communications between chips such that a plurality of chips are connected and processing in array, thereby enhancing parallel computing capability.

FIG. 2 shows structure and timing for the data buffering structure and the programmable operation structure configured for ping-pong operation of data according to another embodiment of the present disclosure.

Referring to FIG. 2, in stage S1, the first data is output from the first data buffering structure 142, and in stage S2, the second data is output to the second data buffering structure 144 after going through the programmable operation structure 130. The programmable operation structure 130 is reconfigured in stage S3. Then, in stage S4, the second data is output to the programmable operation structure 130 again, and in stage S5, the result of operation by the reconfigured programmable operation structure 130 is output to the first data buffering structure 142, thereby configuring the first and second data buffering structures 142 and 144 and the programmable operation structure 130 for ping-pong operation of data.

In accordance with the technical concept of the disclosure, the controller 110 controls whether the programmable operation structure 130 to execute data flow operation. In accordance with some embodiments, the controller 130 determines whether or not to execute data flow operation by the programmable operation structure 130 according to the following equation:

T_conf+T_delay*N/Path«N*T_n (3)

wherein, T_conf is the time at which the programmable operation structure is configured; T_delay is the maximum delay of the data path; N is the number of data to be computed; Path is the number of parallel operations; and T_n is the time required to complete operation for each data in common serial control flow operation mode.

FIG. 3 shows an adaptive chip 300 that may function as the programmable operation structure according to an embodiment of the present disclosure.

As shown in FIG. 3, the adaptive chip 300 includes a plurality of dynamically reconfigurable units 310 arranged in array. Each dynamically reconfigurable unit 310 may be connected with 4˜8 surrounding adjacent dynamically reconfigurable units and may be connected to non-adjacent dynamically reconfigurable units via a plurality of data transfer lines over and below it. Each dynamically reconfigurable unit 310 obtains data from one or more of the connected input ends and outputs operation results based on data to the output end.

For each dynamically reconfigurable unit 310 shown in FIG. 3, data may enter and exit in 8 different directions. That is, data may come from four different adjacent dynamically reconfigurable units 310 and results may be output to eight different adjacent dynamically reconfigurable units 310 after operation for further operation. However, the present disclosure is not limited thereto.

The adaptive chip 300 implements operations according to input data after being configured once. After the operations are completed, it may be erased and reconfigured, then implements new operations according to new input data and so on, thereby realizing the effect of infinite chip area.

The adaptive chip 300 includes several dynamically reconfigurable basic units 310 each of which may register configuration data and be connected with adjacent basic units. According to the configurations, each basic unit obtains data from one or more adjacent basic units and may output the operation results based on these data to at least one adjacent basic units. While data transfer arrives, operations are implemented according to configurations. Infinite circuit algorithms may be implemented on a limited chip area by automatically reconfiguring chips at different times.

In accordance with some embodiments, each dynamically reconfigurable unit 310 may include an arithmetic logic timing unit configured to implement at least one of arithmetic operation, logic operation, lookup operation, path selection operation, floating-point operation, null operation, timing delaying and counting.

The dynamically reconfigurable units 310 have their own instruction set containing controls such as data input selection, data computing operation, data registering or outputting.

Instructions may be 16 bit instructions. 32 bit instructions may also be used to program Row and col in. Specific byte meanings and distributions are described in the below table, wherein byte arrangement or sequence is not necessary reference condition, and different sequence and combinations may be used.

TABLE 1
Arrangement of 16 bit instructions

| Selc | Selb | Sela | |
|---|---|---|---|
| (Cin way | (B way | (A way | p |
| selection) | selection) | selection) | operation) |
| 3 bits | 4 bits | 4 bits | 5 bits |

TABLE 2
Arrangement of 32 bit instructions

| | | Selc | Selb | Sela | |
|---|---|---|---|---|---|
| | | (Cin way | (B way | (A way | Op |
| ow | Column | selection) | selection) | selection) | (operation) |
| bits | 8 bits | 3 bits | 4 bits | 4 bits | 5 bits |

In accordance with some embodiments, each dynamically reconfigurable unit 310 may be dynamically reconfigured as desired, and operation instructions executed by each dynamically reconfigurable unit may be different. Instructions executed by the dynamically reconfigurable units depend on the following equation:

$$\{ cout , Result \} = f ( {\sum }_{n = 0}^{N} {a}_{n} δ ( {x}_{a} - Sela ) , {\sum }_{n = 0}^{N} {b}_{n} δ ( {x}_{b} - Selb ) , {\sum }_{n = 0}^{N} {cin}_{n} δ ( {x}_{c} - Selc ) ) \qquad ( 4 )$$

wherein Sela is a data source specified by configuration of data A, Selb is a data source specified by configuration of data B, Selc is a data source specified by configuration of data Cin, Xₐ are all possible sources of data A, X_{b} are all possible sources of data B, X_{c} are all possible sources of data Cin, N is a path of source through which each data signal may be obtained, for example, n is 4 if four neighborhoods are connected; n is 8 if 8 neighborhoods are connected; and if the unit is connected with bus, then m buses are connected, n is 8+m. f is an operation function, for example, operations such as add, subtract, multiply, left shift, right shift and lookup; aₙ, bₙ, cinₙ are data on the nth way of A, B, Cin respectively, Result is a function result output, cout is a carry bit or flag bit output, δ(xₐ−Sela), δ(x_{b}−Selb) and δ(x_{c}−Selc) and are unit pulse response functions, and if and only if Xₐ=Sela, X_{b}=Selb, and X_{c}=Selc the above three functions are 1s, otherwise 0s.

The following table shows instructions for dynamically reconfigurable units 310 according to an example embodiment of the present disclosure.

TABLE III
Instructions For Dynamically Reconfigurable Units

| Instruction | | | |
|---|---|---|---|
| ID | symbol | function | description |
| 00 | NOP | Null operation | Do nothing |
| 01 | MUX | selection | When Cin is 1, swap |
| | | | locations of a and b and |
| | | | output |
| 02 | AND | AND | AND operation |
| | | operation | |
| 03 | OR | OR operation | OR operation |
| 04 | XOR | XOR | XOR operation |
| | | operation | |
| 05 | ROUTE | Route | Select route for B |
| | | selection | according to A |
| 06 | LSHIFT | Left shift | Left shift |
| 07 | RSHIFT | Right shift | Determine arithmetic right |
| | | | shift or logic right shift |
| | | | depending on most |
| | | | significant bit of Cin or B |
| 08 | CMP | compare | Compare to 0 in terms of |
| | | | magnitude |
| 09 | ABS | absolute value | Take absolute value |
| 10 | NEG | negate | negate |
| 11 | ADDU | Unsigned | Unsigned addition |
| | | addition | |
| 12 | SUBU | Unsigned | Unsigned subtraction |
| | | subtraction | |
| 13 | SASS | Addition or | Cin controls whether to |
| | | subtraction of | add or subtract |
| | | signed | |
| | | numbers | |
| 14 | MERGE | merge | Two partially merged |
| | | | input data |
| 15 | LUT | lookup | Lookup inputs from |
| | | | surrounding units |
| 16 | F2I | floating point | IEEE-54 standard, floating |
| | | to integer | point to integer |
| 17 | I2F | Integer to | IEEE-54 standard, integer |
| | | floating point | to floating point |
| 18 | ACC | accumulator | Accumulated input |
| 19 | COUNTER | counter | Input counting |
| 20 | ADDF | floating point | floating point addition |
| | | addition | |
| 21 | SUBF | floating point | floating point subtraction |
| | | subtraction | |
| 22 | Reserved | reserved | reserved |
| 23 | Reserved | reserved | reserved |
| 24 | MULI | Integer | Integer multiplication |
| | | multiplication | |
| 25 | MULF | floating point | floating point |
| | | multiplication | multiplication |
| 26 | FIFO | queue | first-in first-out buffering |
| 27 | DOTI | Integer dot | Integer data dot |
| | | multiplication | multiplication |
| 28 | DOTF | floating point | floating point data dot |
| | | dot | multiplication |
| | | multiplication | |

In accordance with some embodiments, the plurality of dynamically reconfigurable units 310 may be configured to implement complex instructions by combining at least two of them. A complex instruction is implemented by combining a plurality of basic operation instructions. For example, complex instruction EQU determines whether two integer data are equal, outputs 1 in C way if so, and outputs 0 in C way otherwise. The implementation idea may be subtraction or XOR for the two ways of data and then comparing to 0 with comparing instruction.

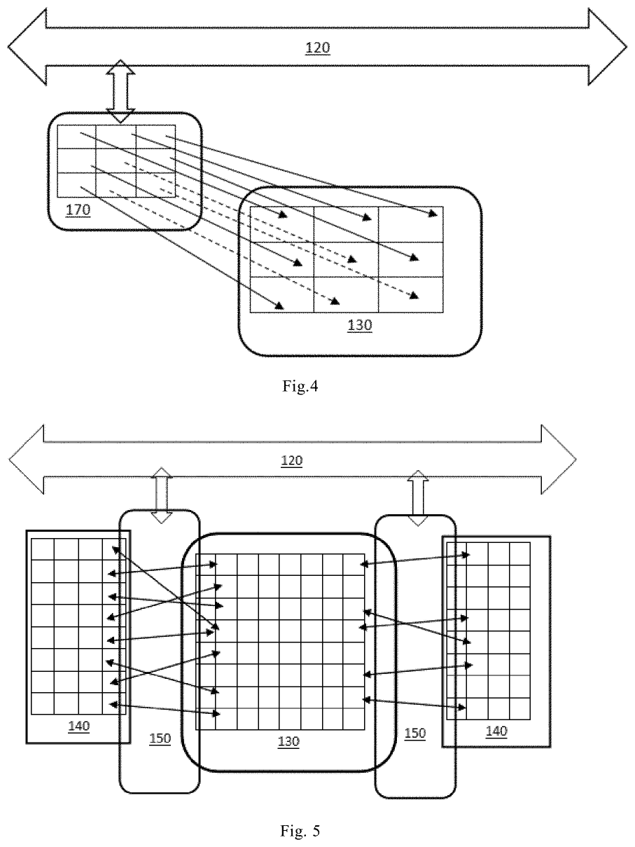

FIG. 4 shows the programmable operation structure 130 with configuration buffer mode according to an example embodiment of the present disclosure.

Referring to FIG. 4, the programmable operation structure 130 adopts a configuration buffer 170. For example, a small memory is used to store configurations to be changed in the next step. When configurations are needed, the next configuration may be stored. When a command obtained via serial controller or bus is a configuration, data in the configuration buffer is written into the reconfigurable operation structure (configuration register) in parallel or serially to save configuration time. With the issuance of switch instruction, instructions written into the buffer are immediately written into the high speed dynamically reconfigurable logic array directly, which may result in an effect of switching every 1˜10 ns.

FIG. 5 shows a diagram of a bus switch 150 adjusting each line of data in the data buffering structure 140 and the connection mode of the programmable operation structure 130 according to an example embodiment of the present disclosure.

Referring to FIG. 5, the bus switch 150 is dynamically reconfigured to adjust each row of data in the data buffering structure 140 and the connection mode of the programmable operation structure 130, which may implement switching of direct transfer of data in different rows or columns. It is understood that the bus switch is a sufficient condition rather than a necessary condition.

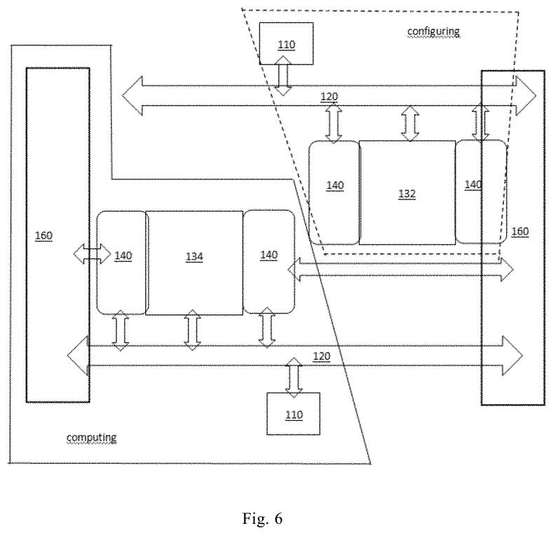

FIG. 6 shows a diagram of configuring a plurality of programmable operation structures according to an example embodiment of the present disclosure.

In accordance with some embodiments of the present disclosure, it is possible to configure a plurality of programmable operation structures and data buffering structures. While allowing a section to go through configurations, allowing another section to implement data processing may accelerate computing performance and reduce switch time. Though redundant resources are needed as compared to the previously-described approach utilizing configuration buffer 170, the plurality of programmable operation structures and data buffering structures may facilitate interconnections, resulting in a shorter switch time.

For example, referring to FIG. 6, the plurality of programmable operation structures 130 include a first programmable operation structure 132 and a second programmable operation structure 134. While the first programmable operation structure 132 is being configured, the second programmable operation structure 134 is in operation. And when the configuration and operation are completed, the second programmable operation structure 134 switches to configuration and the first programmable operation structure 132 switches to operation, thereby realizing successive operations and improving overall operation efficiency.

In accordance with some embodiments of the present disclosure, SIP encapsulation is used for the plurality of chips and/or the plurality of chips and memories to double the computing performance. In accordance with some embodiments, stacked encapsulation is used for the plurality of chips, and master and slave chips are set among the plurality of chips, thereby implementing dynamic scheduling. In this way, it is possible to implement a low power consumption and high performance processor stack that breaking the Moore's Law.

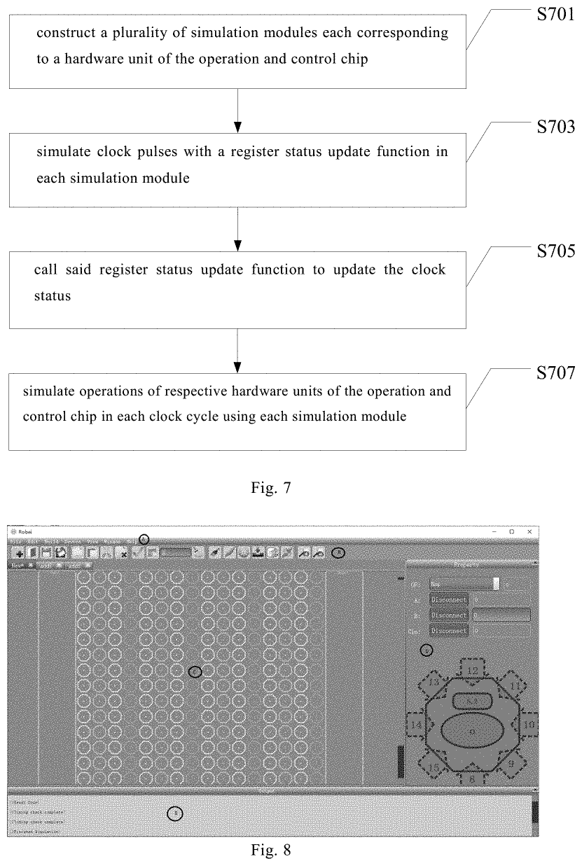

FIG. 7 shows a simulation method for the previously described chip according to an example embodiment of the present disclosure.

Referring to FIG. 7, in the simulation method for the above-described chip according to an example embodiment of the present disclosure, in S701, a plurality of simulation modules are constructed each corresponding to a hardware operation unit of the chip.

In S703, in each simulation module, clock pulses are simulated with a register status update function. Since there is no clock concept in software, in software simulation, hardware circuit is simulated in a way of status updating in which each updating of register status represents one clock pulse on the hardware circuit.

In S705, clock status is updated by calling the register status update function. There is an update function in each simulation module, and the function may be called for status updating while running simulation.

In S707, operations of respective hardware unit of the chip in each clock cycle are simulated with each simulation module. That is, after status updating, then the logic section is simulated for operation.

In accordance with some embodiments, step-by-step execution may be set in software to detect register status corresponding to each clock in the hardware in real time.

In accordance with some embodiments, simulation modules that need clock status updating are subjected to data updating in specific order. For example, while updating data for simulators that need updating register status in an update manner, data may be updated in a specific order to avoid disorder of data timing.

FIG. 8 shows an interface diagram illustrating editing attributes of the programmable operation structure in form of Model-View according to an example embodiment of the present disclosure.

As shown in FIG. 8, according to some embodiments, the at least one programmable operation structure is subjected to attribute editing in form of Model-View. For example, the Model is a built-in simulator for high speed programmable operation array for simulation of each operation unit. When an operation unit is selected, specific attributes of the unit may be edited with the attribute editor and reflected into the Model directly. When an operation unit is selected, the unit is highlighted and transferred to the attribute editor on the right via parameters. Attributes of the unit may be edited in the attribute editor and fed back to the operation unit directly.

In an example embodiment, each computing unit has 3 inputs, A, B and Cin. Each input may be entered in eight directions. Therefore, an eight-direction compass is disposed in the right side attribute column. When a user clicks the location of one of the eight directions with a mouse, the number of this location will be written to the configuration as the input direction, and the arrow of the data is input to the addition or change of units in the workspace and output is obtained from adjacent unit.

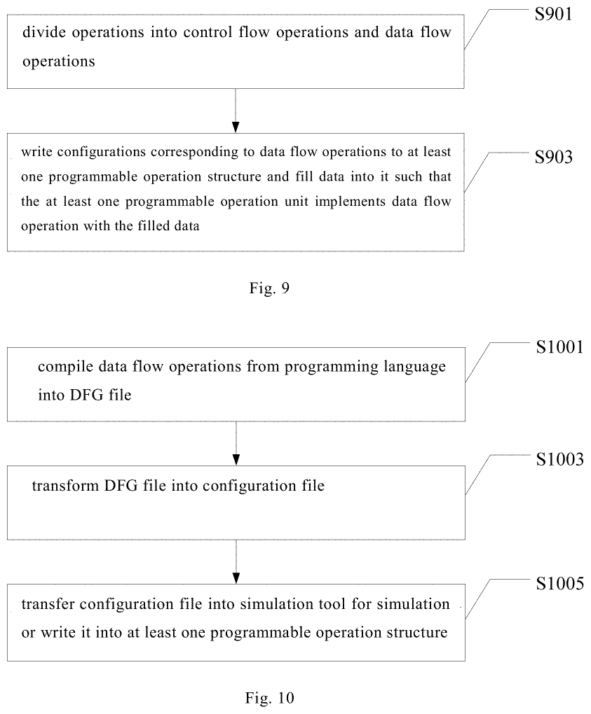

FIG. 9 shows a flow chart of a method for the chip according to an example embodiment of the present disclosure, which can schedule and control operations.

Referring to FIG. 9, in S901, operations are classified into control flow operation and data flow operation. Those suitable for control flow computation may be run on the controller directly, and for those suitable for data flow operations, configurations are first placed into the programmable operation structure. For example, for data flow computation, large amount of data is implemented by the same operation algorithm, and the rest is control flow computation.

As previously noted, in accordance with some embodiments, the controller 130 determines whether or not to execute data flow operation by the programmable operation structure 130 according to the following equation:

T_conf+T_delay*N/Path«N*T_n (5)

wherein, T_conf is the time at which the programmable operation structure is configured; T_delay is the maximum delay of the data path; N is the number of data to be computed; Path is the number of parallel operations; and T_n is the time required to complete operation for each data in common serial control flow operation mode.

In S903, configurations corresponding to data flow operations are written into at least one programmable operation structures and data is filled into the at least one programmable operation structures such that the at least one programmable operation structures implement data flow operations with the filled data.

FIG. 10 shows a flow chart of a method for the chip according to an example embodiment of the present disclosure, which can compile, configure or simulate data flow operations.

Referring to FIG. 10, in S1001, the data flow operations are compiled from a programming language to a DFG file. For example, C codes are flagged as parallel with Clang for compiling and generating DFG file. As another example, a predetermined operation (e.g., C program) is compiled into a structure including a plurality of dynamically reconfigurable units.

In S1003, the DFG file is transformed into a configuration file. For example, a data flow graph is generated directly by means of the DFG file and then corresponds to the chip structure as the configuration.

In S1005, the configuration file is sent to the simulation tool for simulation or is written into at least one programmable operation structure. For example, configurations may be read with software that has implemented entire modeling for chips for data simulation and verification. As another example, configuration parameters of a plurality of configurations are written into a plurality of respective reconfigurable units respectively.

The chip according to the present disclosure may be applied to various scenarios in which high energy efficiency or reliable operations are desired. Examples will be described below. It is readily understood that these are only illustrative applications of the chip according to the present disclosure rather than for limitation.

In accordance with an embodiment, an anti-radiation chip includes the chip according to the present disclosure. The chip is configured to, after detecting radiation inversion of data, be reconfigured in a dynamic reconfiguration mode and/or utilize redundant units to avoid radiation damaged units via dynamic reconfiguration. The anti-radiation chip may be used in applications of astronavigation, aviation and nuclear power.

In harsh environment such as astronavigation and nuclear power, large amount of energetic particle rays exist. For circuitries and detection systems in astronavigation and nuclear power, due to the radiation of particles, data tends to invert, in particular the control data. The chip may not only resist partial dose of radiation by using anti-radiation reinforcing process lines, but also may further enhance the anti-radiation dose by reconfiguring data in a dynamic reconfiguration manner after detecting data inversion. At the same time, due to a large amount of redundancy, the chip may avoid damaged units by dynamic reconfiguration to continue operation, thereby guaranteeing continued operation of chip after damage and prolonging the service life.

Two out of three redundancy may be used for configuration data of each unit. Upon inversion, correct data is found by redundancy check for continued operation. When three data are all different, which indicates two or more bits are inverted at the same time, interruption is triggered directly to request the controller to schedule reconfiguration for self-restoration.

Double backup may also be used. For each backup, dual bit/single bit check is used to determine inversion or not, which may save storage for one way of data and reduce power consumption. It is possible to prevent inversions in nearby regions at the same time with dual bit check.

In accordance with an embodiment, a soft-self-destruction device includes the chip according to the present disclosure. The chip reconfigures at least one programmable operation structure with received algorithm configuration data. When a preset condition is triggered, the chip reconfigures the at least one programmable operation structure on its own to erase the configured algorithm structure. This solution may be used for soft-self-destruction of security devices such as missiles, drones, unmanned ships, unmanned submarines, unmanned chariots. The chip may not store algorithms by itself and algorithms are transferred to at least one programmable operation structure via network. Once an exception is triggered such as timing is expired and being trapped, it may be reconfigured and erase internal algorithm structure on its own.

In accordance with an embodiment, an artificial intelligent computing device or miner includes the chip according to the present disclosure. The chip is adapted to new algorithm by dynamic reconfiguration. For example, the chip may be used for operations of artificial intelligence and operations of miners. Due to the continuous evolution of algorithms, many fixed artificial intelligence algorithms for artificial intelligence and miners' operations will be replaced with optimized ones soon. The programmable chip may be adapted to new algorithms by dynamically adjusting operation mode of data flow.

In accordance with an embodiment, a server chip includes the chip according to the present disclosure. The chip may configure different programmable data flow operation hardware for different algorithms to accelerate operations and/or reduce power consumption. This solution may be applied to fields such as big data, servers and cloud operation as master chips to replace existing server chips. The chip has CPU and parallel operation capabilities itself, which allows the algorithm to configure different programmable data flow operation hardware according to its requirements, thereby realizing dynamic reconfiguration, accelerating operations and reducing power consumption.

In accordance with an embodiment, a robot control chip includes the chip according to the present disclosure for controlling and scheduling robots. Externally connected devices are automatically identified by protocols, and driving circuit configurations and protocols for the devices are inquired over network and downloaded automatically to reconfigure the at least one programmable operation structure. Then the connected device may be used directly.

In accordance with an embodiment, a process defect detection structure includes the chip according to the present disclosure for detecting yield of process plant.

Chips returning from manufacturing plant has defect rates. Even if chips appear to function normally, there may be minor problems inside. Many logic gates cannot satisfy timing requirement in high frequency processes. Logics have no generality. Even if one logic can pass, combinations of logics tend not to satisfy set frequency requirements. According to the detection mode of the present embodiment, heterogeneous units are used inside the chip to realize layout and reconfiguration of 256 to 16,000 cores. All paths and logic computing inside the chip are implemented by gates, which substantially covers all common operations of all CPU, GPU and AI chips. The location of unit where defect exists is detected by skipping defective units through successive iteration. When a path is problematic, problematic units may be skipped by successive traverse for operation. It is also possible to find out problematic units by reversely inferring crossing locations of detected problematic rows and detected problematic columns to be problematic in operation, thereby implementing reverse defect location. By refining, it is possible to figure out operation functions in which defects exist and number of bits where data defects exist. Then they are flagged. It is possible to inform the manufacturer the problem arises at which specific location and which specific line to allow the manufacturer to trace process problem of the defect. Yield detection of a new production line tends to take a very long period to stabilize, of which much time is wasted in locating defects. In accordance with the technical solution of the disclosure, it is possible to assist a new production line to locate logic defects quickly and assist an old production line to improve logic yield, thereby achieving a higher satisfaction of customers for chip design.

In accordance with an embodiment, a baseband processing structure includes the chip according to the present disclosure for baseband data processing of terminal devices or network devices. The chip implements parallel processing by data flow operations of large amount of data. After 4G age, data bandwidth grows rapidly. Prior art practice is to process bandwidth data by a plurality of processors or in a SIMD manner. As previously noted, it is possible to implement parallel processing and reduce power consumption by data flow operations of large amount of data.

In accordance with an embodiment, an SSD controller includes the chip according to the present disclosure for connecting with storage grains and CPUs. The SSD controller is configured such that, for serial operations or data accesses of small amount of data, the chip reads/writes data from/to storage grains and exchanges data with CPU; and for parallel operations of large amount of data, the chip receives configurations for at least one programmable operation structure, is reconfigured with the configurations, executes parallel operations of data inside the storage grains and returns results of the parallel operations to the CPU. It is also possible to encapsulate the chip of the present disclosure together with storage grains in on-chip integration manner such as SIP encapsulation to realize mono-chip storage solution. As the chip becomes more powerful, it is possible to discard CPU directly and replace CPU with the chip to implement in-memory computation with lower power consumption.

In accordance with an embodiment, an image sensing controller includes the chip according to the present disclosure for pre-processing of image sensor data or radar sensor data. The chip receives configuration data and read instructions sent from CPU and the reconfigured chip executes operations on the image sensor data or radar sensor data and returns results to CPU. In this manner, processing of image sensor data or radar data may be moved from CPU side to the sensor side, which reduces transfer of data between CPU and sensors and further reduces the amount of computation. The CPU sends configuration data and read instructions to the sensor side. Data in sensors is computed by the configured chip and results are sent to the CPU. In addition, it is possible to further transmit results to cloud servers over Internet.

In accordance with an embodiment, a computing accelerator includes the chip according to the present disclosure. The chip satisfies requirements for hardware acceleration by different algorithms using dynamic reconfiguration for acceleration of parallel processing of cloud data. The solution may be applied to accelerating data processing in a cloud server. At present, there is a large amount of data for cloud computing platforms, in which much data needs parallel processing. Therefore combination of cloud computing server and FPGA emerges. However, FPGA cannot be dynamically reconfigured with very fast speed. The chips in this solution may satisfy requirements for hardware acceleration by different algorithms using ultra-fast dynamic reconfiguration.

In summary, the programmable chip according to embodiments of the present disclosure, the method for this chip and the device having the chip have one or more of the following advantages.

In accordance with some embodiments, the chip may have a plurality of controllers, buses, programmable operation structures and data buffering structures and can implement high performance parallel processing, thereby realizing high energy efficiency of processing and low power consumption.

In accordance with some embodiments, those suitable for control flow computation may be run on the controller directly, and for those suitable for data flow operations, configurations are first placed into the programmable operation structure, thereby realizing high energy efficiency of processing.

In accordance with some embodiments, it is possible to implement a combination of a plurality of programmable operation structures in a single chip and implement seamless switch between dual configurations or multiple configurations, thereby further improving parallel combining capability.

What have been described above are only example embodiments of the present disclosure rather than limiting the scope of embodiments of the present disclosure. That is, whatever equivalent variations and modifications made according to the present disclosure fall in the scope of the present disclosure.

Other embodiments of the present disclosure easily occur to those skilled in the art upon considering the present description and practicing the present disclosure herein. The present application is intended to encompass any variations, uses or adaptations of the present disclosure that follow the general principle of the present disclosure and include well known knowledges or conventional technical means not set forth in the present disclosure. The description and embodiments are considered as only illustrative and the scope and spirit of the present disclosure are defined only by the claims.

1. A programmable chip, comprising:
at least one controller with a control flow operation mode;
at least one bus;
at least one programmable operation structure with a data flow operation mode that communicates with at least one controller via at least one bus; and
at least one data buffering structure comprised by a buffer and/or a buffer array, exchanging data with at least one programmable operation structure;
wherein at least one controller is configured to control and schedule at least one programmable operation structure and/or at least one data buffering structure, allocate and process serial and parallel data operations and/or dynamically reconfigure at least one programmable operation structure.

2. The chip of claim 1, wherein the at least one controller applied to control and execute other structure and operations, comprised by at least one of CPU, DSP, MCU, GPU and DMA, the at least one controller is further configured to control the execution of control flow operations, which comprises implementing at least one of serial operation, reading data, writing data, jumping, interruption and small amount data operation, and the at least one controller is further configured to control the execution of the data flow operation, which comprises controlling and scheduling the programmable operation structure executing data flow operations.

3-4. (canceled)

5. The chip of claim 1, wherein the at least one data buffering structure comprises a parallel or high speed serial multi-port high bandwidth memory/memory array, the at least one data buffering structure further can be implemented with a plurality of dual port RAMs or one or more high bandwidth RAMs, and the RAMs can be implemented in forms of registers, SRAMs, MRAMs, RRAMs, RERAMs or eFlashes.

6. The chip of claim 1, wherein the at least one data buffering structure exchanges data with the at least one controller for control flow operations and periphery devices via the at least one bus or a DMA.

7. The chip of claim 1, wherein
the at least one data buffer comprises a plurality of data buffering structure distributed around the at least one programmable operation structure and comprising a first and a second data buffering structure; the plurality of data buffering structures and the at least one programmable operation structure are configured to implement ping-pong operations of data.

8-9. (canceled)

10. The chip of claim 1, further comprising:
at least one bus switch placed between the at least one programmable operation structure and the at least one data buffering structure, the at least one bus switch is a programmable or dynamically reconfigurable cross connection structure for connecting the at least one data buffering structure and the at least one programmable operation structure.

11. (canceled)

12. The chip of claim 1, wherein the at least one programmable operation structure implements serial operations in a pipeline or parallel mode, wherein the at least one programmable operation structure comprises at least one of FPGA, DSP, adaptive chip structure, artificial intelligent operation structure and network on chip, etc.

13. The chip of claim 12, wherein the adaptive chip structure comprises a plurality of dynamically reconfigurable units arranged in array. Each dynamically reconfigurable unit is connected with surrounding 4˜8 adjacent dynamically reconfigurable units and connected with non-adjacent dynamically reconfigurable units via one or more plurality of data transfer bus, the each dynamically reconfigurable unit obtains data from one or more of connected unit and outputs operation results based on the data to at least one connected unit, each dynamically reconfigurable unit comprises an arithmetic logic timing unit configured to implement at least one of arithmetic operation, logic operation, lookup operation, path selection operation, floating-point operation, null operation, timing delaying and counting, etc. the plurality of dynamically reconfigurable units may be configured to implement complex instructions by combining at least two of them, and the complex instruction is implemented by combining a plurality of basic operation instructions.

14-17. (canceled)

18. The chip of claim 1, wherein,
the at least one programmable operation structure adopts a configuration buffer mode or partitions into at least two operation areas that implement configuration and operation in an overlapping and parallel manner, thereby realizing parallelized processing and data overlapping, reuse in data processing.

19-20. (canceled)

21. The chip of claim 1, further comprising:
one or more storage interfaces, one or more of MIPI/USB/HDMI/VGA display interfaces, image sensor interfaces, laser radar sensor interfaces, voice interfaces, AD/DA converting interfaces and Serdes interfaces, the one or more storage interfaces further being configured to attach one or more DDR memories, one or more HBM highly parallel memories, one or more HMC memories, one or more SSD/SATA memories with PCIE/USB interfaces, one or more memories with optical communication interfaces and one or more network memories with high speed Ethernet interfaces, one or more built-in MRAM/RRAM/eFlash/SRAM/DRAM memories for high speed storage.

22. The chip of claim 1, further comprising a plurality of programmable interfaces each of which re-defines internal connections by program settings to enable a plurality of structures inside the chip to communicate with outside.

23-24. (canceled)

25. The chip of claim 1, further comprising by forming a processing array or adopt SIP, Stacked or other encapsulation, wherein high speed communication interfaces for communications between the chips applies such that a plurality of chips are connected and processing in an array.

26-27. (canceled)

28. A simulation method for the chip of claim 1, comprising:
constructing a plurality of simulation modules, each simulation module corresponding to a hardware operation unit of the chip;
in each simulation module, simulating clock pulses with a register status update function;
updating clock status by calling the register status update function;
simulating operations of respective hardware unit of the chip in each clock cycle with each simulation module;
simulation modules that need clock status updating to data updating in a specific order;
detecting respective register status of each clock in the hardware operation unit in real time by setting step by step execution; and
subjecting the at least one programmable operation structure to attribute editing in form of Model-View.

29-31. (canceled)

32. A method for the chip of claim 1, comprising: classifying operations into control flow operations and data flow operations; writing configurations corresponding to data flow operations into at least one programmable operation structures and filling data into at least one programmable operation structures such that at least one programmable operation structures implement data flow operations with the filled data.

33. The method for the chip of claim 32, further comprising:
compiling the data flow operations from a programming language to a data flow graph (DFG) file;
transforming data flow graph (DFG) file into a configuration file;
sending configuration file to a simulation tool for simulation or writing configuration file into the at least one programmable operation structure.

34-35. (canceled)

36. A massive computing device like artificial intelligent computing device or miner or a server comprising the chip of claim 1, wherein the chip is adapted to new algorithms by dynamic reconfiguration, wherein the chip configures different programmable data flow operation for different algorithms to accelerate operations and/or reduce power consumption.

37. (canceled)

38. The massive computing device of claim 36 is a robot control chip comprising the chip of claim 1 for controlling and scheduling, wherein externally connected devices are automatically identified by protocols or scheduling tasks to be downloaded automatically, and driving circuit configurations and protocols for the devices are inquired over network and downloaded automatically to reconfigure the at least one programmable operation structure.

39. The massive computing device of claim 36 is a process defect detection structure comprising the chip of claim 1 for detecting yield of a process plant.

40. The massive computing device of claim 36 is a baseband processing structure comprising the chip of claim 1 for baseband data processing of a terminal device or a network device, wherein the chip implements parallel processing by data flow operations of large amount of data.

41. The massive computing device of claim 36 is an in device processing device like SSD controller or an image sensing controller comprising the chip of claim 1 for reducing data transfer between controller and device, SSD Controller connecting storage grains and a CPU, or replacing the CPU directly, wherein the SSD controller is configured such that: for serial operations of small amount of data, the chip reads data from the storage grains and transfer it to the CPU; for parallel operations of large amount of data, the chip receives configurations for at least one programmable operation structure, is reconfigured with the configurations, executes parallel operations of data inside the storage grains and returns results of the parallel operations to the CPU; the chip may contain a CPU therein and may be monolithically encapsulated with memories;
Image sensing controller pre-processing of image sensor data or radar sensor data, wherein:
the chip receives configuration data and reads instructions sent from the CPU and the reconfigured chip executes operations on the image sensor data or radar sensor data and returns results to the CPU.

42-43. (canceled)
